(19) United States
(12) Patent Application Publication
(10) Pub. No.: US 2024/0254805 A1
(43) Pub. Date: Aug. 1, 2024

(54) CONTAINER DOOR LATCHING MECHANISM AND RELATED METHOD FOR OPERATING SAME

(71) Applicant: POWERBRACE CORPORATION, Kenosha, WI (US)

(72) Inventors: Richard M. CHARNEY, South Milwaukee, WI (US); Christopher C. GAYDOS, Burlington, WI (US); Joseph CENTENO, Kenosha, WI (US)

(21) Appl. No.: 18/420,925

(22) Filed: Jan. 24, 2024

Related U.S. Application Data
(60) Provisional application No. 63/442,542, filed on Feb. 1, 2023.

(51) Int. Cl. E05B 13/00; E05C 9/08

(52) U.S. Cl. CPC E05B 13/002; E05C 9/08

(57) ABSTRACT

A door latching mechanism operably carried on a cargo door. The latching mechanism operates a lock assembly between a locked condition and an unlocked condition. The door latching mechanism includes a base mounted to an exterior side of the door. The door latching mechanism further includes a manually operated handle movable about a first axis, with the handle being operably connected to and moves the lock assembly between conditions. To facilitate one-handed operation of the door latching mechanism, a lock actuator is carried by the handle. The lock actuator and the base define cooperating instrumentalities for releasably securing the handle in a first position, wherein the cooperating instrumentalities engage to inhibit rotation of the handle and thereby the lock assembly toward an unlocked condition. The lock actuator is manually rotatable on the handle, to disengage the cooperating instrumentalities and allow the handle to manually move the lock assembly toward the unlocked condition whereby permitting the door to be positioned to access to the cargo container interior. A method for operating a door latching mechanism is also disclosed.

### RELATED APPLICATION

This patent application relates to a co-pending and co-assigned U.S. PROVISIONAL patent application, namely U.S. patent application Ser. No. 63/442,542 filed Feb. 1, 2023, the entirety of which is incorporated herein by reference.

### TECHNICAL FIELD

The present invention disclosure generally relates to a door latching mechanism for releasably latching a door on a cargo container in a closed position and, more specifically, to a door latching mechanism which presents a reduced profile and is configured to facilitate one-handed operation of the door latching mechanism. A method for operating a door latching mechanism is also disclosed.

### BACKGROUND

Cargo containers are generally utilized for the purpose of providing a relatively compact and safe place to temporarily store materials and typically have hinged doors at one end for allowing ready and quick access to an interior of the container. Many of such containers are arranged on wheeled chassis to facilitate movements between distant locations. Some such containers are also equipped with a hinged and latchable door on one or both sides of the container for allowing access to the container interior from a side thereof.

The door on the side of the cargo container is typically operated by some type of mechanism that latches and unlatches the door and includes an operating handle mounted for movements between locked and unlocked positions. In one form, the latches used to latch and unlatch the door on the container include elongated links which operate in response to movements of the handle between the locked and unlocked positions. In the handle's locked position, the latches maintain the door in a closed position thus inhibiting access to the interior of the container. Whereas, moving the handle to the unlocked position conditions the latches to allow the door to be opened and thus permitting access to the interior of the cargo container.

Of course, mounting the door latching mechanism on the side of the container renders the handle of such mechanism susceptible to accidental movement and operation of the latch mechanism. In an effort to avoid trees and related debris which tend to brush the side of the container and, thus, can inadvertently move the handle from a locked toward the unlocked position, it is known to securely mount the locking mechanism within a recess provided on an exterior side of the door. As such, the potential for inadvertent movement of the handle is minimized.

To further minimize the potential for inadvertent movement of the handle from the locked position toward the unlocked position, it is known to provide a lock in operable association with the door latching mechanism. Understandably, it has also been found both beneficial and desirable to configure the door latching mechanism such that one-handed operation of the door latching mechanism is easily and readily accomplished. In one known embodiment, such a lock mechanism tends to require the operator to use one hand for successfully operating the lock and a second hand for pivoting and pulling the handle from the locked position to the unlocked position.

As such, it has been found desirable to configure the handle of the door latching mechanism such that the operator of the door locking mechanism can concomitantly assert both pivoting movements and pulling action to the handle using but a single hand. Unfortunately, and as will be appreciated by those skilled in the art, pivoting and pulling on the handle of the latching mechanism tends to cause the operator's hand to slip/slide toward a free end of the handle thus complicating the one-handed release of the latching mechanism.

For these and other reasons, there is a continuing need and a desire of a recessed door latching mechanism which embodies a pivotal handle with a releasable lock for latching and unlatching a door on a side of the cargo container and which is configured to facilitate one-handed operation of the latching mechanism.

### SUMMARY

In view of the above, and in accordance with one embodiment of the present invention disclosure, there is provided a door latching mechanism operably carried on a cargo door that moves between open and closed positions. The cargo door has interior and exterior generally parallel sides. The latching mechanism operates a lock assembly carried on the door for rotation about a first axis between a locked condition, wherein the lock assembly maintains the door in a closed position, and an unlocked condition, wherein the door is permitted to move to allow access to an interior of a container through an opening arranged in general registry with the door.

In one form, the door latching mechanism includes a base adapted to be operably mounted to the exterior side of the door. The door latching mechanism further includes a manually operated handle movable about a first axis, with the handle being operably connected to and rotates the lock assembly between locked and unlocked conditions. To facilitate one-handed operation of the door latching mechanism, a lock actuator is carried by the handle. The lock actuator and the base define cooperating instrumentalities for releasably securing the handle in a first position, wherein the cooperating instrumentalities engage to inhibit rotation of the handle and thereby the lock assembly toward an unlocked condition. The lock actuator is manually rotatable on the handle, to disengage the cooperating instrumentalities and allow the handle to manually move the lock assembly toward the unlocked condition whereby permitting the door to be positioned to permit access to the cargo container interior.

In one form, the handle of the door latching mechanism has an elongated configuration. Preferably, the handle of the door latching mechanism includes a narrowed free-ended handle portion joined to a mounting portion which is pivotable about the first fixed axis. The handle is configured to allow for pivotal movement of the handle about the first axis. In one embodiment, the handle of the door latching mechanism has a free end. Preferably, the free end of the handle is configured to allow an operator of the door latching mechanism to grasp and rotate the handle while conjointly restricting movement of the operator's hand as the handle is pulled to move the door toward an open position.

In a preferred embodiment, the lock actuator of the door latching mechanism is pivotally carried by the handle for manual rotation about a second axis extending generally parallel to the first axis. Preferably, the lock actuator is spring biased toward a locked condition.

The cooperating instrumentalities for releasably securing the handle in the first position while allowing the handle to manually rotate and move the bar lock assembly toward an unlocked condition upon manual rotation of the lock actuator preferably comprises: a cooperating pair of camming surfaces defined by the base and the lock actuator. The camming surfaces are configured to move into and out of engagement relative to each other depending upon the position of the lock actuator.

More specifically, and in one embodiment, the cooperating instrumentalities for releasably securing the handle in the first position while allowing the handle to manually pivot and move the bar lock assembly toward an unlocked condition upon manual rotation of the lock actuator comprises: a pair of upright spaced leg flanges on the base and depending spaced flanges on the lock actuator. Confronting surfaces on the upright spaced leg flanges on the base and the depending spaced flanges on the lock actuator each include camming surfaces configured to act in concert with each other to releasably secure the handle in the first position while allowing the handle to be manually pivoted thus moving the bar lock assembly toward an unlocked condition upon manual rotation of the lock actuator.

In an alternative embodiment the base includes an upstanding leg which, after the base is mounted to the door, extends away from the exterior surface of the door. In this alternative embodiment, the lock actuator is spring biased and includes a pair of depending laterally spaced flanges integrally connected to each other by a bight portion which, when the handle is in a first position, extends over the mounting portion of the handle. The lock actuator is pivotally carried by the handle for manual rotation about a second axis extending generally parallel to the first axis. The bight portion of the handle acts as a stop for limiting pivotal movement of the lock actuator in a first pivotal direction about the second axis.

In this embodiment of the door latching mechanism, the mounting portion of the handle and the lock actuator each define openings. Peripheral edges of the openings are sized and arranged relative to each other to allow the upstanding leg on the base to project therethrough when the handle is in the first position. When the lock actuator is released, the openings are furthermore configured to allow the handle to pivot from the first position and thereby rotate the bar lock assembly. Preferably, the free end of the upstanding leg on the base has a camming surface for facilitating return of the cooperating instrumentalities from the released position to a position wherein the cooperating instrumentalities secure the handle in a first position.

In this alternative embodiment, the cooperating instrumentalities for releasably securing the handle in the first position while allowing the handle to manually rotate and move the bar lock assembly toward an unlocked condition upon manual rotation of the lock actuator comprises: a tab on and movable with the lock actuator. The tab on the lock actuator is configured to removably engage an open-sided notch defined on the upstanding leg on the base to releasably retain the handle in the first position. The tab on the lock actuator is removable from the notch upon pivotal rotation of the lock actuator to a released position to disengage the cooperating instrumentalities and allow the handle to manually rotate the bar lock assembly toward the unlocked condition whereby permitting the door to be positioned to allow access to the cargo container interior.

According to another aspect of this invention disclosure, there is provided a door latching mechanism operably carried on a door movable between closed and open oppositions on a cargo container. The door has exterior and interior sides with a recess being provided in and opening to the exterior side of the door. The door latching mechanism is capable of being connected to a lock assembly pivotable about a first axis and movable from a locked condition, wherein the lock assembly maintains the door in a locked position relative to an opening in the container, to an unlocked condition, wherein the lock assembly allows the door to be moved to an open position whereby allowing access to an interior of the cargo container.

According to this aspect of the present invention disclosure, the door latching mechanism includes a latch housing configured to securely reside within the recess defined by the door. The housing has a bottom surface and a peripheral side wall extending from the bottom wall to define an open-sided latch receiving cavity. A base is mounted within the open-sided cavity and securely extends from the bottom surface of the latch housing. A manually operated handle is pivotable about the first axis. The handle is operably connected to and rotates the lock assembly between locked and unlocked conditions. A lock actuator is carried by the handle for rotation about a second axis and, in one form, is spring biased toward a locked condition. Preferably, the second axis extends generally parallel to the first axis. The lock actuator and the base define cooperating instrumentalities for releasably securing the handle in a first position, wherein the cooperating instrumentalities engage to inhibit rotation of the handle and thereby the bar lock toward an unlocked condition. The lock actuator is manually rotatable toward an unlocked position about the second axis whereby disengaging the cooperating instrumentalities and thus allowing the handle to be manually rotated whereby moving the bar lock toward the unlocked position to permit the door to be positioned to permit access to the container interior.

In one form, the handle has an elongated configuration including a mounting portion which pivotably connects the handle to the lock assembly and a handle portion having a free end. The free end of the handle portion is preferably configured to allow an operator of the door latching mechanism to grasp and rotate the handle while conjointly restricting movement of the operator's hand as the handle is pulled to move the cargo door toward an open position.

In one form, the cooperating instrumentalities defined by the lock actuator and the base comprises: a cooperating pair of camming surfaces defined by the base and the lock actuator. The cooperating camming surfaces are configured to move into and out of engagement relative to each other depending upon the position of the lock actuator.

More specifically, the cooperating instrumentalities defined by the lock actuator and the base preferably includes a pair of upright spaced leg flanges on the base. In one form, the pair of upright spaced leg flanges on the base are disposed to opposed sides of the mounting portion on the handle. Preferably, the cooperating instrumentalities further includes depending spaced flanges on the lock actuator which are disposed to opposed sides of the mounting portion of the handle. In this embodiment, confronting surfaces on the upright spaced leg flanges on the base and the depending spaced flanges on the lock actuator each include camming surfaces configured to act in concert with each other to releasably secure the handle in the first position while allowing the handle to manually rotate upon manual rotation of the lock actuator so as to move the bar lock toward an unlocked condition.

In another form of the present invention disclosure, the base includes an upstanding leg. After the base is mounted within the recess defined by the door, the leg on the base extends away from the exterior surface of the door. In this alternative embodiment, the lock actuator is spring biased and includes a pair of depending flanges disposed to opposed sides of a mounting portion of the handle. The depending flanges on the lock actuator are connected to each other by a bight portion which, when the handle is in a first position, extends over the mounting portion of the handle. Preferably, the bight portion on the lock actuator acts as a stop for limiting pivotal movement of the spring biased lock actuator in a first pivotal direction about the second axis.

In this alternative embodiment, the mounting portion of the handle and the lock actuator each define openings. Peripheral edges of the openings are sized and arranged relative to each other to allow the upstanding leg on the base to project therethrough when the handle is in the first position. Moreover, and when the lock actuator is released, the openings in the mounting portion of the handle and lock actuator are configured to allow the handle to pivot from a first position to rotate the bar lock.

In an alternative embodiment, the cooperating instrumentalities defined by the lock actuator and the base includes a tab movable with the lock actuator for removably engaging an open-sided notch on the upstanding leg on the base to releasably retain the handle in the first position. The tab on the lock actuator is removable from the notch on the leg upon pivotal rotation of the lock actuator to a released position to disengage the cooperating instrumentalities and allow the handle to be manually moved to rotate the bar lock toward the unlocked condition whereby permitting the door to be positioned to permit access to the container interior.

Preferably, the free end of the upstanding leg on the base has a camming surface for facilitating return of the cooperating instrumentalities from the released position to a position wherein the cooperating instrumentalities secure the handle in a first position. In a preferred form, the upstanding leg on the base and the mounting portion on the handle are configured to accommodate an indicator for readily indicating whether the lock actuator has been rotated about the second axis to move the handle from the first position.

According to still another aspect of this invention disclosure, there is provided a door latching mechanism operably carried on a door of a cargo container and is movable between closed and open positions. The door has interior and exterior sides and an outwardly facing recess provided in the exterior side of the door. The latching mechanism is capable of being connected to a plurality of elongate links having latches movable between a locked condition, wherein the latches maintain the door in a closed and locked position relative to an opening in the cargo container, and an unlocked condition, wherein the latches allow the door to move to an open position whereby allowing access to an interior of the cargo container.

According to this aspect of the invention disclosure, the door latching mechanism includes a latch housing configured to securely reside within the outwardly facing recess defined by the door. The housing has a bottom surface and a peripheral side wall extending from the bottom wall to define an open-sided latch receiving cavity. A base is mounted within the open-sided latch receiving cavity defined by the housing and securely extends from the bottom surface of the latch housing. A manually operated handle is pivotable about a first axis from a locked and nested position within the open-sided latch receiving cavity to an extended and unlocked position. The handle is operably connected to and upon rotation thereof moves the links thereby operating the latches between their locked and unlocked conditions. A lock actuator is carried by the handle and is preferably spring biased toward a locked condition. The lock actuator and the base define cooperating instrumentalities for releasably securing the handle in a first position, wherein the cooperating instrumentalities engage to inhibit the handle from pivoting about the first axis and inhibit movement of the latches from their locked condition. The lock actuator is manually rotatable, preferably about a second axis extending generally parallel to the first axis, to disengage the cooperating instrumentalities and allow the handle to move from the locked position toward the unlocked position whereby releasing the latches thus permitting the door to be moved to permit access to the container interior.

Preferably, the handle has an elongated configuration including a narrowed free-ended handle portion joined to a mounting portion which is pivotable about the first axis. A mounting portion of the handle is pivotably connected to the latch housing. The free end of the handle is configured to allow an operator of the door latching mechanism to grasp and rotate the handle while conjointly restricting movement of the operator's hand as the handle is pulled to move the door toward an open position.

In one embodiment, the cooperating instrumentalities defined by the lock actuator and the base include a cooperating pair of camming surfaces defined by the base and the lock actuator. The camming surfaces are configured to move into and out of engagement relative to each other depending upon the position of the lock actuator.

In one form, the cooperating instrumentalities defined by the lock actuator and the base includes a pair of upright laterally spaced leg flanges on the base. Preferably, the laterally spaced leg flanges are disposed to opposed sides of the mounting portion of the handle. The depending and laterally spaced flanges on the lock actuator are disposed to opposed sides of the mounting portion of the handle. Confronting surfaces on the upright spaced leg flanges on the base and the depending spaced flanges on the lock actuator each include camming surfaces configured to act in concert with each other to releasably secure the handle in the first position while allowing the handle to be manually rotated so as to move the bar lock toward an unlocked condition upon manual rotation of the lock actuator.

In an alternative embodiment, the base includes an upstanding leg which, after the base is mounted within the recess defined by the door, extends away from the exterior surface of the door. In this alternative embodiment, the lock actuator is spring biased and includes a pair of laterally spaced, depending flanges disposed to opposed sides of the mounting portion of the handle. The laterally spaced and depending flanges on the lock actuator are connected to each other by a bight portion which, when the handle is in a first position, extends over the mounting portion of the handle. The bight portion of the handle acts as a stop for limiting movement of the lock actuator in a first direction about the second axis.

Preferably, the mounting portion of the handle and the lock actuator each define openings. Peripheral edges of the openings are sized and arranged relative to each other to allow the upstanding leg on the base to project therethrough when the handle is in the first position. The peripheral edges of the openings in the handle and base are configured to allow the handle to pivot from the first position to rotate the bar lock.

The cooperating instrumentalities defined by the lock actuator and the base preferably include a tab movable with the lock actuator for removably engaging an open-sided notch on the upstanding leg of the base to releasably retain the handle in the first position. Upon rotation of the lock actuator, the tab on the lock actuator is moved from the notch to a released position to disengage the cooperating instrumentalities and allow the handle to manually rotate the bar lock toward the unlocked condition whereby permitting the door to be positioned to permit access to the container interior.

In a preferred form, the free end of the upstanding leg on the base has a camming surface for facilitating return of the cooperating instrumentalities from the released position to a position wherein the cooperating instrumentalities secure the handle in a first position. Preferably, the upstanding leg on the base and the mounting portion on the handle are configured to accommodate an indicator for clearly indicating whether the lock actuator has been rotated about the second axis to move the handle from the first position.

According to another aspect of this invention disclosure there is provided a method for conditioning a lock assembly so as to releasably hold a cargo container door in a closed position relative to an opening in a side of the cargo container. The lock assembly has a movable lock member which operably interacts with a stationary lock member. The method comprises the steps of; securing a door latching mechanism to the exterior side of the door. The door latching mechanism includes a base operably secured to an exterior side of said door. Another step in the process involves mounting a manually operable handle to the base for movements about a first axis. The handle is operably connected to and operates the lock assembly in response to pivotal movement of the handle about the first axis. Another step in the process involves providing a lock actuator on the handle for movement about a second axis. The lock actuator is configured to facilitate one handled operation of the door latching mechanism. The lock actuator and base define cooperating instrumentalities for either releasably securing the handle in a first position, wherein the cooperating instrumentalities engage to inhibit movement of the handle and thereby hold the lock assembly to an unlocked condition, and with the lock actuator being movable to disengage the cooperating instrumentalities and allow the handle to manually move the lock assembly toward the unlocked condition whereby permitting the door to be positioned to permit access to an interior of the container.

The preferred method for conditioning a lock assembly so as to releasably hold a cargo container door in a closed position relative to an opening in a side of the cargo container includes the further step of: recessing the door latching mechanism from an exterior side of the door to inhibit inadvertent operation of the door latching mechanism.

### DESCRIPTION OF THE DRAWINGS

FIG. 1 is a side view of a cargo container having a door with a door latching mechanism according to this invention disclosure;

FIG. 2 is a sectional view taken along line 2-2 of FIG. 3;

FIG. 3 is an enlarged plan view of the door latching mechanism illustrated in FIG. 1;

FIG. 4 is an enlarged fragmentary sectional view taken along line 4-4 of FIG. 2 an showing one form of latching mechanism;

FIG. 5 is an enlarged fragmentary sectional view similar to FIG. 4 but showing the latching mechanism in a released position/condition;

FIG. 6 is an enlarged fragmentary section view similar to FIG. 4 but showing an alternative form of latching mechanism; and

FIG. 7 is an enlarged fragmentary sectional view similar to FIG. 6 but showing the alternative latching mechanism in a released position/condition.

### DETAILED DESCRIPTION

While this invention disclosure is susceptible to embodiment in various forms, there is shown in the drawings and will hereinafter be described preferred embodiments, with the understanding the present invention disclosure is to be considered as setting forth exemplifications of the disclosure which are not intended to limit the invention disclosure to the specific embodiments illustrated and described.

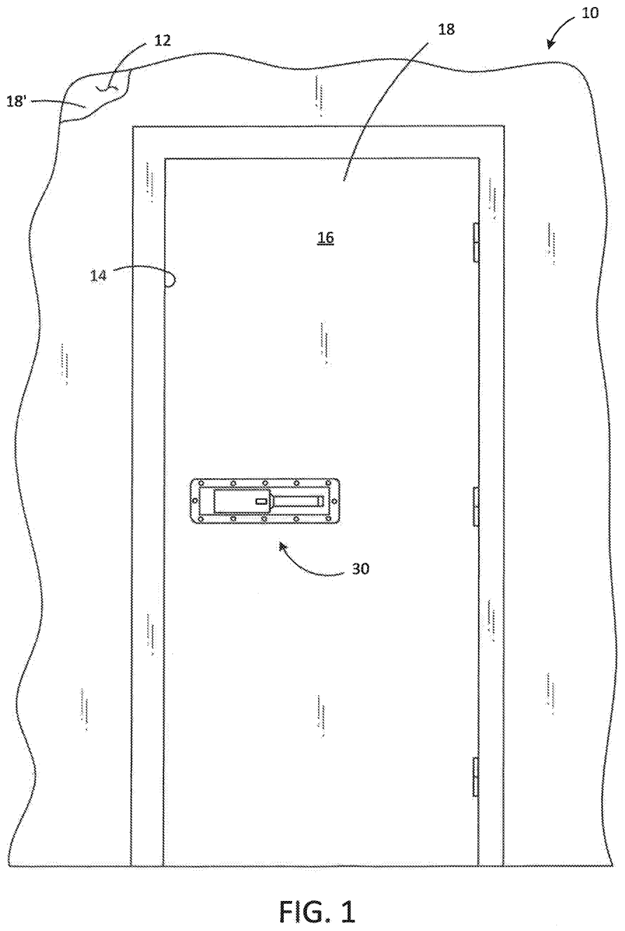

Referring now to the drawings, wherein like reference numerals indicate like parts throughout the several views, FIG. 1 depicts a side of a cargo container 10 suitable for storing and transporting goods within an interior 12 thereof. It will be appreciated, however, the teachings and principals of the present invention disclosure will and do equally apply to other forms of cargo containers. Cargo container 10 defines an opening 14 for providing ingress and egress to and from the interior 12 of container 10. As is typical, a hinged door 16, movable between open and closed positions, is arranged in registry with the opening 14. The door 16 has an exterior side 18 and an interior side 18′ opposite form and extending generally parallel to the exterior side.

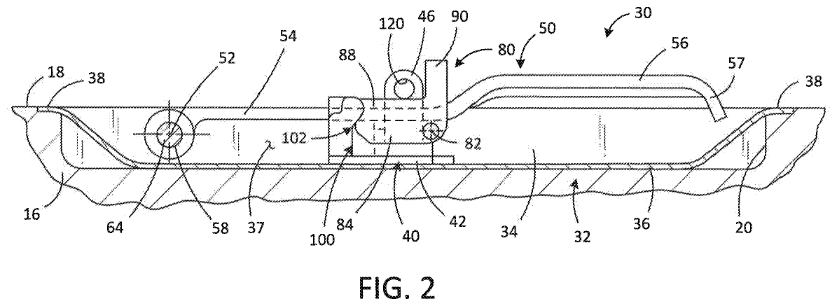

Turning to FIG. 2, and to at least conceal or recess the door latching mechanism of the present invention from the respective outer side of the cargo container 10, door 16 defines a generally rectangularly shaped open-sided cavity or recess 20 provided in and opening to the exterior side 18 of door 16. Preferably, the outwardly facing recess 20 may be a stub mortise cut into the exterior side 18 of door 16 without passing completely through the opposing interior side of the door 16.

In one embodiment, the door latching mechanism of this invention disclosure, generally indicated by reference numeral 30, includes a latch housing 32 configured to securely reside within the outwardly facing recess 20 defined by door 16. In one form, the latch housing 32 is of a generally rectangular shape and includes a peripheral wall 34 extending from a bottom wall 36. The peripheral wall 34 and bottom wall 36 cooperatively form a recessed area 37. Preferably, a peripheral flange 38 is formed at the outer end of the peripheral wall 34 and is adapted to mount the latch housing 32 flush with the exterior side 18 of door 16 (for example by suitable fasteners through fastener holes defined by the peripheral flange 38).

The door latching mechanism 30 also includes a base 40 adapted to be operatively mounted to the exterior side 18 of door 16. In a preferred embodiment, base 40 is securely mounted within the open-sided cavity or recess area 37 of latch housing 32 and extends from the bottom wall or surface 36 of the latch housing 32.

The door latching mechanism 30 includes a manually operated handle 50 which, in a preferred embodiment, is pivotable about a first fixed axis 52. The handle 50 pivots between a locked and nested condition and an unlocked condition. In the illustrated embodiment, and with the handle 50 and latching mechanism 30 in a locked and nested condition, the majority of the handle 50 is substantially recessed within recessed area 37 of the latch housing 32 so as to avoid being inadvertently engaged by debris, i.e. tree limbs and the like brushing against or otherwise sweeping past and/or engaging with the exterior side of the container 10. As used herein, and as best illustrated in FIG. 2, the phrase “substantially recessed” means the handle 50 has limited exposure outwardly from the peripheral flange 38 of the latch housing 32.

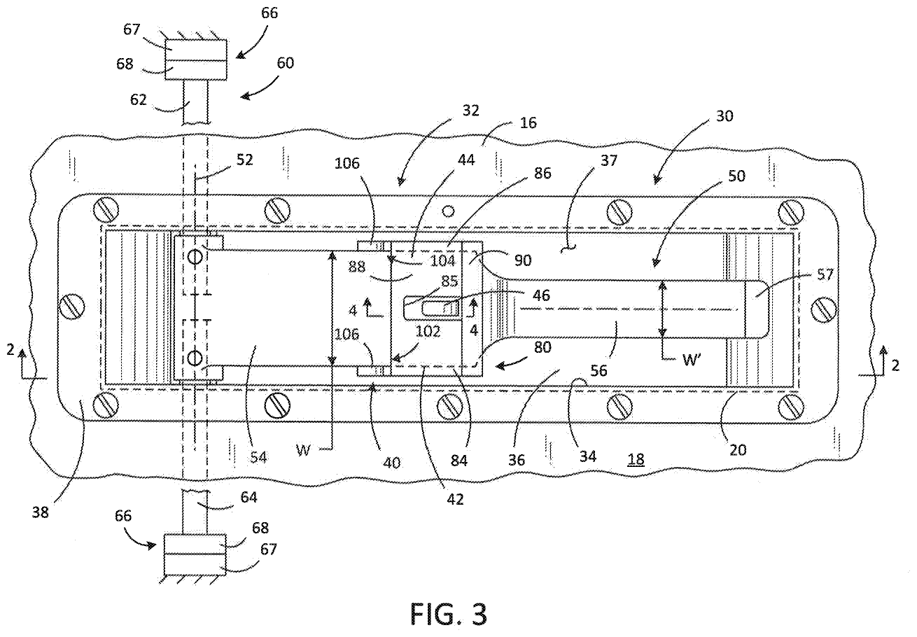

In a preferred form, the handle 50 has an elongated configuration between opposed ends thereof. Preferably, the handle 50 has a mounting or first portion 54 which pivots about the fixed axis 52 and a second free-ended handle portion 56. In the exemplary embodiment illustrated in FIG. 3, the handle portion 56 has a width W′ which is substantially less than the width W of the mounting portion 52 of handle 50. Returning to FIG. 2, when the handle 50 in the locked condition, the handle portion 56 is adequately spaced from the bottom wall 36 of the latch housing 32 to readily permit an operator of the door latching mechanism 30 to readily wrap their hand about the handle portion 56 to facilitate movement of the handle 50 from the locked condition to an unlocked condition. Preferably, the free-second end of the handle portion 56 is configured to allow the operator of the door latching mechanism 30 to grasp and rotate the handle 50 while conjointly restricting movement of the operator's hand toward the free-end of the handle 50 as the handle 50 is pulled to move the door 16 toward an open position. Preferably, the second free end of the handle 50 is configured with a downwardly angled portion 57 for advantageously affecting these desired ends.

The door latching mechanism 30 of the present invention disclosure is capable of being connected to a lock assembly or mechanism, generally indicated in FIG. 3 by reference numeral 60. In one form, the lock assembly 60 includes elongated links 62 and 64. In a typical fashion, each link 62, 64 has a latch 66 arranged in operable combination therewith and which is movable between a locked condition, wherein the latch 66 maintains the door 16 in a closed position relative to the opening 14 (FIG. 1) in the cargo container 10, and an unlocked condition. In the unlocked condition, latches 66 allow door 16 to be moved to an open position whereby allowing access to the interior 12 (FIG. 1) of the cargo container 10.

As will be readily appreciated by those skilled in the art, the lock assembly or mechanism 60 along with latches 66 can take any of a myriad of different designs without detracting or departing from the spirit and broad scope of this invention disclosure. In one form, mechanism 60 is designed as a bar lock assembly having the latches 66 arranged in vertically spaced relative to each other. Preferably, the latches 66 are substantially similar to each other and, thus, only one latch 66 will be described in detail. As practiced in the art, each latch 66 preferably embodies a conventional and well-known design including a stationary keeper 67 arranged in operable association with a rotatable retainer hook or cam 68. As is known, and in the illustrated embodiment, retainer hook or cam 68 moves between a locked condition and an unlocked condition relative to the respective keeper 67. In one form, each hook or cam 68 moves in response to rotation of the respective keeper 67 and in response to movement of the respective link 62, 64. In the locked condition, the retainer hook 68 operates in combination with the respective keeper 67 to releasably maintain door 16 in the locked position relative to the opening 14 (FIG. 1) in the cargo container 10. In an unlocked condition, the retainer hook 68 is released from its operable association with the respective keeper 67 to allow the door 16 to freely move toward an open position relative to the opening 14 in the cargo container 10 whereby permitting access to the interior 12 of the container.

In the illustrated embodiment, each retainer hook 68 is arranged for rotation about the first fixed axis 52 and in combination with one end of the respective elongate link 62, 64. In the illustrated embodiment, the elongate links 62, 64 are also configured for rotation about the first fixed axis 52. The other end of each elongated link 62, 64 is operably secured to the mounting portion 54 of handle 50. In the illustrated embodiment, the mounting portion 54 of handle 50 is configured with an axial throughbore or opening 58 which is preferably coaxially arranged with the first axis 52. The bore 58 is configured to accommodate an end of each elongate link 62, 64. As depicted in FIG. 3, each elongated link 62, 64 is pinned or otherwise suitably secured to the handle 50 such that, when the handle 50 is rotated/pivoted about axis 52, the lock assembly 60 is simultaneously operated to lock/unlock the door 16 relative to the opening 14 in the cargo container 10 (FIG. 1).

The door latching mechanism base 40 is adapted to be operably mounted to and extend outwardly from the exterior side 18 of door 16. In a preferred embodiment, and when the handle 50 is in a first or locked condition (FIG. 2), the base 70 of the door latching mechanism 30 underlies the mounting portion 54 of the handle 50. In exemplary form shown in FIG. 3, base 70 has opposed and generally parallel sides 74 and 76.

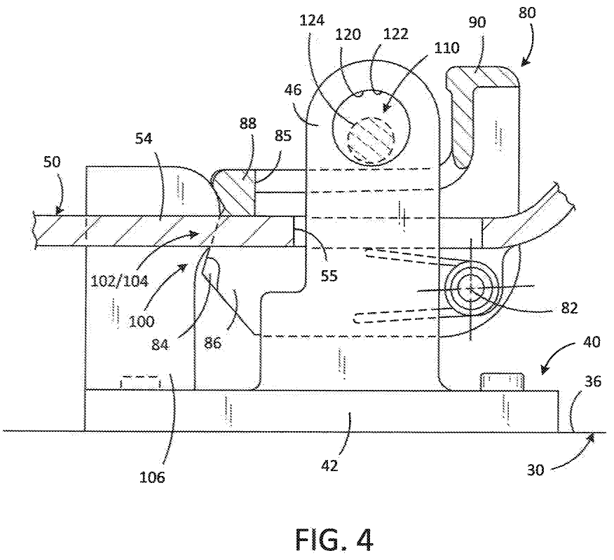

To facilitate one-handed operation thereof, the door latching mechanism 30 of the present invention disclosure also includes a manually operated lock actuator 80 carried on the handle 50. Preferably, the lock actuator 80 is carried on the handle 50 for pivotal movements about a second axis 82 (FIG. 2) extending generally parallel to the first axis 52. In one embodiment, the lock actuator 80 is spring biased in a first counterclockwise as shown in FIG. 4 toward a locked condition wherein the handle 50 is releasably maintained in the first, locked and nested condition/position.

In one embodiment, a portion of the lock actuator 80 has an inverted generally U-shaped configuration including a pair of generally parallel and laterally spaced depending flanges 84 and 86 which embrace the mounting portion 54 of the handle 50 therebetween. The depending flanges 84 and 86 on the lock actuator 80 are rigidly joined to each other by a bight portion 88. When the lock actuator 80 is in a first or locked position, shown in FIGS. 3 and 4, the bight portion 88 extends over and engages the mounting portion 54 of the handle 50 so as to limit pivotal rotation of the handle 50 in a first direction about axis 52.

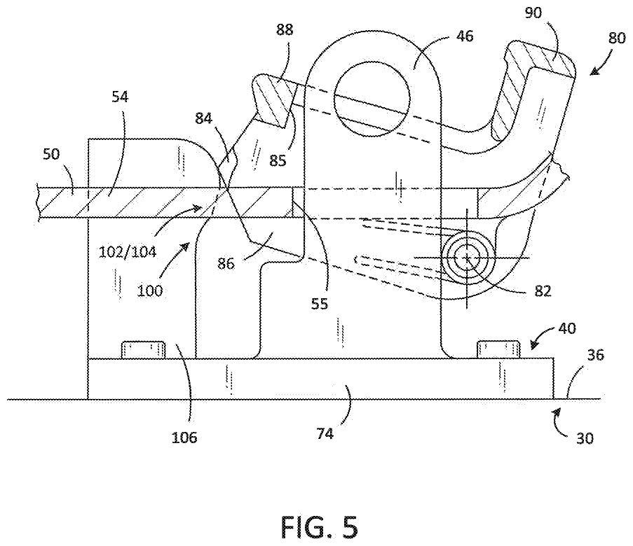

To facilitate one-handed operation of the lock actuator 80, and in a preferred embodiment, the actuator 80 furthermore includes an engagement member 90. It will be appreciated by those skilled in the art, the engagement member 90 can take different designs and/or configurations without detracting or departing from the spirit and scope of this invention disclosure. Suffice it to say, the engagement member 90 is preferably configured to allow an operator to quickly, readily and pivotally move the actuator 80 in a second direction about the second axis 82 and to a second or released position (FIG. 5), against the spring bias of actuator 80, so as to release and allow the handle 50 to be moved to a second, unlocked condition or position. Technically, the engagement member 90 extends from the lock actuator 80 and radially away from axis 82 so as facilitate one-handed manual rotation of the lock actuator 90.

Cooperating instrumentalities, generally indicated by reference numeral 100, are provided for releasably maintaining the handle 50 in the first locked position/condition. When the handle 50 of the latching mechanism 30 is in the first locked position/condition (FIGS. 2 and 4), the cooperating instrumentalities 100 engage with each other to inhibit rotation of the handle 50 and thereby condition the lock assembly 60 (FIG. 1) to hold the door 16 closed and locked relative to the opening 14 in the cargo container 10 as by inhibiting operation of the latches 66. From an understanding of this invention disclosure, it will be understood, the cooperating instrumentalities 100 are responsive to operation of the lock actuator 80 carried on the handle 50. That is, when the lock actuator 80 is manually rotated about axis 82 from the position shown in FIG. 4 to the position shown in (FIG. 5), the cooperating instrumentalities 100 disengage whereby allowing the handle 50 to be manually rotated about axis 52 thereby moving members 67 and 68 of latches 66 out of engagement relative to each other and toward their unlocked condition so as to permit the door 16 to be poisoned to permit access to the interior 12 of the cargo container 10 (FIG. 1).

It should be appreciated that the design of the cooperating instrumentalities 100 can take on a myriad of different configurations without detracting or departing from the spirit and scope of this invention disclosure. In one form, the cooperating instrumentalities 100 includes two sets or pairs of camming surfaces 102 and 104 defined by the base 60 and the lock actuator 80. Each set or pair of camming surfaces 102, 104 are configured to concomitantly move into and out of engagement relative to each other depending on the position/condition of the lock actuator 80. That is, and with the lock actuator 80 in its first or locked condition (FIG. 4), each pair or set of camming surfaces 102, 104 engage with each other to inhibit rotation of the lock actuator 80 about axis 82 whilst concomitantly inhibiting rotation of the handle 50 (FIG. 2) from its first or locked position/condition and toward the open or unlocked condition/position. When the lock actuator 80 is manually rotated toward an unlocked condition (FIG. 5), each pair or set of camming surfaces 102, 104 disengage from each other to permit rotation of the lock actuator 80 about axis 82 whilst also permitting rotation of the handle 50 toward an unlocked position or condition.

Preferably, each set or pair of camming surfaces 102, 104 are identical. Accordingly, only one set or pair of camming surfaces 102, 104 will be described in detail. As depicted in FIG. 3, each side 74, 76 of the base 70 of the door latching mechanism preferably includes an upright leg flange 106 disposed to one side of the base 70 and to one side of the mounting portion 54 of the handle 50. Preferably, the leg flanges 106 along with the depending 84 and 86 on the lock actuator 80 are arranged in generally coplanar relationship relative to each other.

In this embodiment, each leg flange 106 carries or has camming surface 102 formed thereon. Similarly, each depending flange 84, 86 on the lock actuator 80 carries or has camming surface 104 formed thereon. When the lock actuator 80 is assembled to the base 70, the camming surfaces 102, 104 defined thereon are arranged in confronting and engaging relation relative to each other. As will be understood, the camming surfaces 102, 104 are configured to act in concert with each other and in conjunction with the position of the pivot axis 82 to readably secure the handle 50 in the first position (FIG. 4) as long as the lock actuator 80 is in the first or locked position (FIG. 4). Notably, however, and upon manual rotation of the lock actuator 80 to an unlocked condition/position (FIG. 5), the camming surfaces 102, 104 are configured to move past each other and allow the handle 50 to be manually pivoted about axis 52 (FIG. 2) whereby moving the lock assembly 60 toward an unlocked condition.

In the embodiment depicted in FIGS. 4 and 5, the mounting portion 54 of the operating handle 50 defines an opening 55 which is configured to allow an upstanding leg 42 on base 40 to pass and project upwardly therethrough. Moreover, and as shown in the embodiment depicted in FIGS. 4 and 5, the bight portion 88 on the lock actuator 80 defines an opening 85 which is configured to allow the upstanding leg 42 on base 40 to pass and project upwardly therethrough. Peripheral or marginal lateral edge portions of the openings 55 and 85 defined by the mounting portion 54 of the operating handle 50 and the bight portion 88 on the lock actuator 80, respectively, are configured and arranged relative to each other to allow the upstanding leg 42 on base 40 to pass and project upwardly therethrough. For reasons discussed below, the lateral distance separating the marginal lateral edges on the opening 85 defined by the bight portion 88 on the lock actuator 80 proximates the lateral width of the upstanding leg 42 extendable therethrough.

Preferably, the door latching system 30 furthermore includes an indicator 110 for providing a quick and readily available visual indication of whether the latching system 30 has been operated to open the door 16 on the cargo container 10 (FIG. 1). It will be appreciated, the indicator 110 can take any of a myriad of different configurations and designs without detracting or departing from the spirit and scope of this invention disclosure. In one form illustrated by way of example in FIG. 4, when the handle 50 is in a first or locked position/condition, and in an area of the leg 42 disposed above the handle 50, leg 42 defines an aperture or throughbore 120 extending from one side of the leg 42 to the other. The bore or aperture 120 has a closed marginal edge 122 and is sized to accommodate a shank portion 124 of a suitable lock (not shown) extending therethrough whereby inhibiting substantial pivotal movement of the handle 50 about axis 52 (FIG. 2) from the first or locked condition/position toward a second or unlocked condition/position. Of course, if the shank portion 124 is broken or otherwise tampered with, such condition will provide a quick and ready indication the latching mechanism 0 has been tampered with.

Alternatively, a closed ended wire-like tab can extend through the opening or aperture 120 in the upwardly projecting leg 42 of base 40. As a result of the configurations of the free-end of leg 42 and the opening 55 in the handle 50, the handle 50 is inhibited from moving from the first or locked position without breaking or otherwise damaging the closed ended wire-like tab so as to provide a clear indication the handle 50 was moved toward the second position/condition.

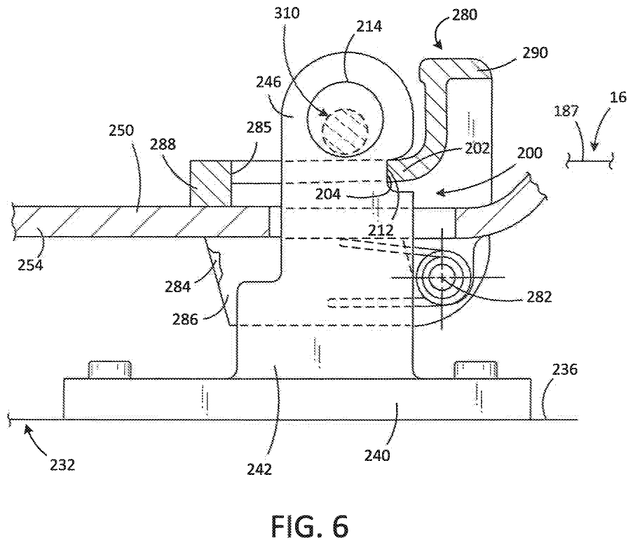

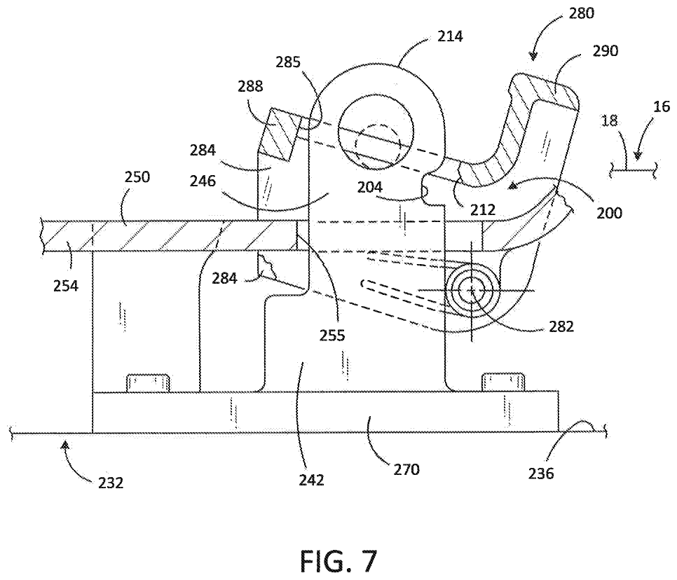

As mentioned, the cooperating instrumentalities for maintaining and releasably holding the handle of the door latching mechanism in a first position/condition can take a myriad of different configurations without detracting or departing from the spirit and scope of this invention disclosure. In this regard, an alternative embodiment for the cooperating instrumentalities used to releasably hold the operating handle of the door latching mechanism in a first position and, thus, maintaining the door 16 in a closed position is illustrated by way of example in FIGS. 6 and 7. This alternative form for the cooperating instrumentalities is generally indicated by reference numeral 200. The elements of the alternative cooperating instrumentalities embodiment which are similar to those mentioned above regarding the cooperating instrumentalities 100 are identified by reference numerals in the 200 series. Similarly, the other elements of the door latching mechanism which are similar to those mentioned above are identified by reference numerals in the 200 series.

In this alternative embodiment, the cooperating instrumentalities 200 includes a base 240 adapted to be operably mounted to and extend outwardly from the exterior side 18 of door 16. As with base 40, and in the embodiment illustrated set forth by way of example in FIGS. 6 and 7, base 240 is securely mounted to the bottom wall 236 of housing 232 within the open-sided cavity or recess defined by the latch housing 232. Preferably, and in the illustrated embodiment, when the handle 250 is in a first or locked condition, a majority of the base 240 underlies the mounting portion 254 of the handle 250. As shown in FIGS. 6 and 7, base 240 preferably includes a rigid upstanding and generally centralized leg 242 projecting upwardly and outwardly from the bottom wall 236 of housing 232 away from exterior side 18 of door 16.

As described above, the door latching mechanism 30 having the alternative cooperating instrumentalities 200 arranged as part thereof includes a manually operated lock actuator 280 carried on the handle 250. Preferably, lock actuator 280 is carried on the handle 250 for pivotal movements about an axis 282 extending generally parallel to the first axis 52 (FIGS. 2 and 3) about which handle 250 pivots. In one embodiment, lock actuator 280 is spring biased in a counterclockwise direction toward a locked condition (FIG. 6) wherein the handle 250 is releasably maintained in the first, locked and nested condition/position.

Although the cooperating instrumentalities 200 have an alternative configuration from the cooperating instrumentalities 100 described above, the lock actuator 280 is substantially similar. Like the lock actuator 80 described above, the lock actuator 280 shown in FIGS. 6 and 7 preferably has an inverted generally U-shaped configuration including a pair of generally parallel and laterally spaced depending flanges 284 and 286 which embrace the mounting portion 254 of the handle 250 therebetween. The depending flanges 284 and 286 on the lock actuator 280 are rigidly joined to each other by a bight portion 288. When the lock actuator 280 is in a first or locked position, the bight portion 288 extends over, engages and presses against the mounting portion 254 of the handle 250. The bight portion 288 on the lock actuator 280 also serves to limit pivotal rotation of the lock actuator 280 in a counterclockwise direction about axis 282 as shown in FIG. 6.

As described above, to facilitate operation of lock actuator 280, an engagement member 290 is preferably provided on or in combination with the actuator 280. Such an engagement member is preferably configured to allow an operator to quickly, readily and pivotally rotate the actuator 280 in a clockwise direction about the second axis 282 and to a second or released position (FIG. 7), against the spring bias of actuator 280, so as to release and allow the handle 250 to be rotated to a second, unlocked condition or position. As will be appreciated by those skilled in the art, the engagement member 290 can take any of a myriad of different design configurations without detracting or departing from the spirit and scope of this invention disclosure. As with engagement member 90, the engagement member 290 technically extends from the lock actuator 280 and radially away from axis 282 so as facilitate manual rotation of the lock actuator 290.

In the embodiment depicted in FIGS. 6 and 7, the mounting portion 254 of the operating handle 250 defines an opening 255 which is configured to allow the upstanding leg 242 on base 240 to pass and project upwardly therethrough. Moreover, and as shown in the embodiment depicted in FIGS. 6 and 7, the bight portion 288 on the lock actuator 280 defines an opening 285 which is configured to allow the upstanding leg 242 on base 20 to pass and project upwardly therethrough. Peripheral or marginal edge portions of the openings 255 and 285 defined by the mounting portion 254 of the operating handle 250 and the bight portion 288 on the lock actuator 280, respectively, are configured and arranged relative to each other to allow the upstanding leg 242 on base 240 to pass and project upwardly therethrough. For reasons discussed below, the lateral distance separating the marginal side edges on the opening 285 defined by the bight portion 288 on the lock actuator 280 proximates the lateral width of the upstanding leg 242 extendable therethrough.

As in the first embodiment, when the handle 250 of the latching mechanism 30 is in the first locked position/condition, the cooperating instrumentalities 200 engage with each other to inhibit rotation of the handle 250 and thereby condition the lock assembly 60 to hold the door 16 closed and locked relative to the opening 14 in the cargo container 10 as by inhibiting operation of the latches 66. From an understanding of this invention disclosure, and as is with the first embodiment, the cooperating instrumentalities 200 are responsive to operation of the lock actuator 280. That is, when the lock actuator 280 is manually rotated about axis 282, the cooperating instrumentalities 200 disengage whereby allowing the handle 250 to be manually rotated about axis 52 (FIG. 2) thereby moving members 67 and 68 of latches 66 (FIG. 3) out of engagement relative to each other and toward their unlocked condition so as to permit the door 16 to be poisoned to permit access to the interior 12 of the cargo container 10. In this alternative configuration, and as best illustrated in FIGS. 6 and 7, when the operating handle 250 of the latching mechanism is in a first or locked position/condition (FIG. 6), the cooperating instrumentalities 200 are designed to inhibit unwarranted rotation of the handle 250. In this embodiment, the cooperating instrumentalities 200 includes a spring biased tab 202 on and movable with the lock actuator 280 and which is inwardly directed toward the leg 242 on base 240. As illustrated, and when handle 250 of the latching mechanism is in a first or locked position/condition, the tab 202 on the lock actuator 280 is configured to be releasably accommodated within an open-sided notch 204 on the upstanding leg 272 on base 270. In a preferred embodiment, the open-sided notch 204 is defined toward a free-end of the leg 272 on base 270.

With such an arrangement, tab 202 and notch 204 are configured to act in concert with each other to readably secure the handle 250 in the first position as long as the lock actuator 280 is in the first or locked position. The handle 250 is permitted to be manually moved about axis 252 and move the lock assembly 60 toward an unlocked condition upon manual rotation of the lock actuator 280 about axis 282 once the tab 202 is removed from the notch 204 thus allowing the handle 250 to pivot and release the members 67 and 68 of latches 66 (FIG. 2) from their operative engagement relative to each other and toward their unlocked condition so as to permit the door 16 to be poisoned to permit access to the interior 12 of the cargo container 10.

Preferably, the cooperating instrumentalities 200 furthermore includes camming surfaces 210 and 212 for facilitating the automatic return of the cooperating instrumentalities 200 to the first or locked condition relative to each other under the influence of the spring-biased lock actuator 280 from a released position to a position wherein the cooperating instrumentalities 200 secure the handle 250 in position to inhibit rotation of the handle 250 and thereby condition the lock assembly 60 to hold the door 16 closed and locked relative to the opening 14 in the cargo container 10 as by inhibiting operation of the latches 66. As will be understood, as the handle 250 returns to its first or locked position, the camming surface 212 on the lock actuator 280 is configured to engage with the camming surface 210 at the free-end of the upstanding leg 242 on base 240 to cause the lock actuator 289 to pivot clockwise as shown in FIG. 6. As the handle 250 progresses toward a locked condition, the camming surface 212 on the lock actuator 280 eventually moves past the camming surface 210 on the leg 242 and, under the influence of the spring biased lock actuator 280, automatically returns to engagement within the notch 204 on the leg 242 whereby inhibiting the handle 250 from pivoting about axis 282 so as to maintain the locking members 67 and 68 (FIG. 2) in their operative engagement relative to each other so as to inhibit the door 16 from being moved toward an open position.

As with the first embodiment, the door latching system 30 furthermore includes an indicator 310 for providing a quick and readily available visual indication of whether the latching system 30 has been operated to open the door 16 on the cargo container 10 (FIG. 1). It will be appreciated, the indicator 280 is substantially similar to either embodiment of indicator 110 discussed above.

According to another aspect of this invention disclosure, there is disclosed a method for conditioning a lock assembly 60 so as to releasably hold a cargo container door 16 in a closed position relative to an opening 14 in a side of a cargo container 10. The lock assembly 60 has a movable lock member 68 which operably interacts with a stationary lock member 67. The method comprises the steps of; securing a door latching mechanism 30 to the exterior side 18 of the door 10. The door latching mechanism 30 includes a base 70, 240 operably secured to the exterior side 18 of the door 10. Another step in the process involves mounting a manually operable handle 50 to the base 40 for movements about a first axis 52. The handle 50 is operably connected to and operates the lock assembly 60 in response to pivotal movement of the handle 50 about the first axis 52.

Another step in the process involves providing a lock actuator 80, 280 on the handle 50 for movement about a second axis 82. The lock actuator 80, 280 is configured to facilitate one handled operation of the door latching mechanism 30. The lock actuator 80, 280 and base 70, 240 define cooperating instrumentalities 100, 200 for either releasably securing the handle 50 n a first position, wherein the cooperating instrumentalities 100, 200 engage to inhibit movement of the handle 50 and thereby hold the lock assembly 60 to an unlocked condition, and with the lock actuator 80, 280 being movable to disengage the cooperating instrumentalities 100, 200 and allow the handle 50 to manually move the lock assembly 60 toward the unlocked condition whereby permitting the door 16 to be positioned to permit access to an interior 12 of the container 10.

The preferred method for conditioning a lock assembly to releasably hold a cargo container door in a closed position relative to an opening in a side of the cargo container includes the further step of: recessing the door latching mechanism from an exterior side of the door to inhibit inadvertent operation of the door latching mechanism.

From the foregoing, it will be observed that numerous modifications and variations can be made and effected without departing or detracting from the true spirit and novel concept of the invention disclosure. Moreover, it will be appreciated, the present invention disclosure is intended to set forth exemplifications which are not intended to limit the disclosure to the specific embodiments illustrated and described. Rather this disclosure is intended to cover by the appended claims all such modifications and variations as fall within the spirit and scope of the claims.

1. A door latching mechanism operably carried on a door movable between open and closed positions, with said door having interior and exterior generally parallel sides, and with said latching mechanism serving to operate a lock assembly carried on said door for rotation about a first fixed axis between a locked condition, wherein said lock assembly maintains said door in a closed position, and an unlocked condition, wherein said door is permitted to move to allow access to a container interior through an opening arranged in general registry with said door, said door latching mechanism comprising:
a base adapted to be operably mounted to the exterior side of said door;
a manually operated handle movable about the first fixed axis, with said handle being operably connected to and operates said lock assembly between locked and unlocked conditions; and
a lock actuator carried by said handle, with said lock actuator and said base defining cooperating instrumentalities for either releasably securing said handle in a first position, wherein said cooperating instrumentalities engage to inhibit movement of said handle and thereby said bar lock assembly toward an unlocked condition, and with said lock actuator being manually rotatable, to disengage said cooperating instrumentalities and allow said handle to manually move said bar lock assembly toward the unlocked condition whereby permitting said door to be positioned to permit access to the container interior.

2. The door latching mechanism according to claim 1, wherein said handle has an elongated configuration including a mounting portion that is configured to allow for pivotal movement of handle about said first axis and a handle portion having a free end.

3. The door latching mechanism according to claim 2, wherein the handle portion of said handle is configured to allow an operator of said door latching mechanism to grasp and move said handle while conjointly restricting movement of the operator's hand toward the free end of the handle as said handle is pulled to move said door toward an open position.

4. The door latching mechanism according to claim 1, wherein said lock actuator is carried by said handle for manual rotation about a second pivot axis extending generally parallel to said first pivot axis.

5. The door latching mechanism according to claim 4, wherein said lock actuator is spring biased toward a locked condition.

6. The door latching mechanism according to claim 1, wherein the cooperating instrumentalities for releasably securing said handle in the first position while allowing said handle to manually move said lock assembly toward an unlocked condition upon manual of said lock actuator comprises: a cooperating pair of camming surfaces defined by said base and said lock actuator, with said camming surfaces being configured to move into and out of engagement relative to each other depending upon the position of said lock actuator.

7. The door latching mechanism according to claim 1, wherein said handle includes a narrowed free-ended handle portion joined to a mounting portion which is pivotable about said first fixed axis.

8. The door latching mechanism according to claim 7, wherein the cooperating instrumentalities for releasably securing said handle in the first position while allowing said handle to manually pivot and move said bar lock assembly toward an unlocked condition upon manual rotation of said lock actuator comprises: a pair of upright spaced leg flanges on said base, and depending laterally spaced flanges on said lock actuator, and with confronting surfaces on the upright spaced leg flanges on said base and the depending spaced flanges on said lock actuator each including camming surfaces configured to act in concert with each other to releasably secure said handle in the first position while allowing said handle to manually pivot and move said bar lock assembly toward an unlocked condition upon manual rotation of said lock actuator.

9. The door latching mechanism according to claim 7, wherein said base includes an upstanding leg which, after said base is mounted to said door, extends away from the exterior surface of said door.

10. The door latching mechanism according to claim 9, wherein said lock actuator is spring biased and includes a pair of depending laterally spaced flanges connected to each other by a bight portion which extends over the mounting portion of said handle, and wherein said lock actuator is pivotally carried by said handle for manual rotation about a second fixed pivot axis extending generally parallel to said first pivot axis, and with the bight portion of said handle acting as a stop for limiting pivotal movement of said lock actuator in a first pivotal direction about said second fixed pivot axis.

11. The door latching mechanism according to claim 10, wherein the mounting portion of said handle and the bight portion on the lock actuator each define openings, with peripheral edges of said openings being sized and arranged relative to each other to allow a free end of the upstanding leg on said base to projects therethrough when said handle is in said first position.

12. The door latching mechanism according to claim 11, wherein the cooperating instrumentalities for releasably securing said handle in the first position while allowing said handle to manually rotate so as to move said lock assembly toward an unlocked condition upon manual rotation of said lock actuator comprises: a tab on and movable with the lock actuator for removably engaging an open-sided notch defined by the upstanding leg on said base to releasably retain the handle in said first position, and with the tab on said lock actuator being removable from said notch upon pivotal rotation of said lock actuator to a released position to disengage said cooperating instrumentalities and allow said handle to manually rotate said bar lock assembly toward the unlocked condition whereby permitting said door to be positioned to permit access to the container interior.

13. The door latching mechanism according to claim 12, wherein said upstanding leg on said base has a camming surface for facilitating return of said cooperating instrumentalities from the released position to a position wherein the cooperating instrumentalities secure said handle in a first position.

14. A door latching mechanism operably carried on a door movable between closed and open oppositions on a container, with said door having an exterior side and an interior side opposite from said exterior side and a recess provided in and opening to the exterior side of the door, with said latching mechanism being capable of being connected to a lock pivotable about a first axis and movable from a locked condition, wherein said lock maintains said door in a locked position relative to an opening in said container, to an unlocked condition, wherein said lock allows said door to be moved to an open position whereby allowing access to an interior of said container, said door latching mechanism comprising:
a latch housing configured to securely reside within the recess defined by said door, with said housing having a bottom surface and a peripheral side wall extending from the bottom wall to define an open-sided latch receiving cavity;
a base mounted within said open-sided cavity and securely extending from the bottom surface of said latch housing;
a manually operated handle pivotable about the first axis, with said handle being operably connected to and rotates said lock between locked and unlocked conditions; and
a lock actuator carried by said handle for rotation about a second axis, with said lock actuator and said base defining cooperating instrumentalities for either releasably securing said handle in a first position, wherein said cooperating instrumentalities engage to inhibit rotation of said handle and thereby said lock toward an unlocked condition, and with said lock actuator being manually rotatable about said second axis to disengage said cooperating instrumentalities and allow said handle to manually rotate said lock toward the unlocked position whereby permitting said door to be positioned to permit access to the container interior.

15. The door latching mechanism according to claim 14, wherein said handle has an elongated configuration including a mounting portion pivotally connected to said latch housing and a handle portion having a free end.

16. The door latching mechanism according to claim 15, wherein the free end of the handle portion said handle is configured to allow an operator of said door latching mechanism to grasp and rotate said handle while conjointly restricting movement of the operator's hand as said handle is pulled to move said door toward an open position.

17. The door latching mechanism according to claim 14, wherein said second axis extends generally parallel to said first axis.

18. The door latching mechanism according to claim 18, wherein said lock actuator is spring biased toward a locked condition.

19. The door latching mechanism according to claim 14, wherein the cooperating instrumentalities defined by said lock actuator and said base comprises: a cooperating pair of camming surfaces defined by said base and said lock actuator, with said camming surfaces being configured to move into and out of engagement relative to each other depending upon the position of said lock actuator.

20. The door latching mechanism according to claim 14, wherein said handle includes a narrowed free-ended handle portion joined to a mounting portion which is pivotable about said first axis.

21. The door latching mechanism according to claim 15, wherein the cooperating instrumentalities defined by said lock actuator and said base comprises: a pair of upright spaced leg flanges on said base which are disposed to opposed sides of the mounting portion of said handle, and depending spaced flanges on said lock actuator which are disposed to opposed sides of the mounting portion of said handle, and with confronting surfaces on the upright spaced leg flanges on said base and the depending spaced flanges on said lock actuator each include camming surfaces configured to act in concert with each other to releasably secure said handle in the first position while allowing said handle to manually rotate so as to move said lock toward an unlocked condition upon manual rotation of said lock actuator.

22. The door latching mechanism according to claim 20, wherein said base includes an upstanding leg which, after said base is mounted within the recess defined by the door extends away from the exterior surface of said door.

23. The door latching mechanism according to claim 22, wherein said lock actuator is spring biased and includes a pair of depending flanges disposed to opposed sides of the mounting portion of said handle and which are connected to each other by a bight portion which extends over the mounting portion of said handle, and wherein said lock actuator is pivotally carried by said handle for manual rotation about a second axis extending generally parallel to said first axis, and with the bight portion of said handle acting as a stop for limiting pivotal movement of said lock actuator in a first pivotal direction about said second axis.

24. The door latching mechanism according to claim 23, wherein the mounting portion of said handle and the bight portion on said lock actuator each define openings, with peripheral edges of said openings being sized relative to each other to allow a free end of the upstanding leg on said base to project therethrough when said handle is in said first position.

25. The door latching mechanism according to claim 24, wherein the cooperating instrumentalities defined by said lock actuator and said base comprises: a tab movable with the lock actuator for removably engaging an open-sided notch on said upstanding leg on said base to releasably retain the handle in said first position, and with the tab on said lock actuator being removable from said notch upon pivotal rotation of said lock actuator to a released position to disengage said cooperating instrumentalities and allow said handle to manually rotate said lock toward the unlocked condition whereby permitting said door to be positioned to permit access to the container interior.

26. The door latching mechanism according to claim 24, wherein the upstanding leg on said base has a camming surface for facilitating return of said cooperating instrumentalities from the released position to a position wherein the cooperating instrumentalities secure said handle in a first position.

27. The door latching mechanism according to claim 24, wherein the upstanding leg on said base and the mounting portion on said handle are configured to accommodate an indicator capable of indicating whether the lock actuator has been rotated about the second axis to move said handle from the first position.

28. A door latching mechanism operably carried on a door movable between closed and open oppositions on a container, with said door having an exterior side and an interior side opposite from said exterior side and an outwardly facing recess provided in the exterior side of the door, with said latching mechanism being capable of being connected to a plurality of elongate links having latches movable between a locked condition, wherein said latches maintain said door in a closed position relative to an opening in said container, and an unlocked condition, wherein said latches allow said door to move to an open position whereby allowing access to an interior of said container, said door latching mechanism comprising:
a latch housing configured to securely reside within the outwardly facing recess defined by said door, with said housing having a bottom surface and a peripheral side wall extending from the bottom wall to define an open-sided latch receiving cavity;
a base mounted within said open-sided cavity defined by said housing and securely extending from the bottom surface of said latch housing;
a manually operated handle pivotable about a first axis from a locked and nested position within said open-sided latch receiving cavity defined by said latch housing to an extended and unlocked position, with said handle being operably connected to and moves said links thereby operating the latches between said locked and unlocked conditions; and
a lock actuator carried by said handle, with said lock actuator and said base defining cooperating instrumentalities for either releasably securing said handle in a first position, wherein said cooperating instrumentalities engage to inhibit said handle from pivoting about said first axis thereby inhibiting movement of said latches from their locked condition, and with said lock actuator being manually rotatable, to disengage said cooperating instrumentalities and allow said handle to move from the locked position toward the unlocked position whereby releasing said latches thus permitting said door to be moved to permit access to the container interior.

29. The door latching mechanism according to claim 28, wherein said handle has an elongated configuration including a mounting portion pivotably connected to said latch housing and joined to a handle portion having a free end.

30. The door latching mechanism according to claim 29, wherein the handle portion of said handle is configured to allow an operator of said door latching mechanism to grasp and rotate said handle while conjointly restricting movement of the operator's hand as said handle is pulled to move said door toward an open position.

31. The door latching mechanism according to claim 28, wherein said second axis extends generally parallel to said first axis.

32. The door latching mechanism according to claim 28, wherein said lock actuator is spring biased toward a locked condition.

33. The door latching mechanism according to claim 28, wherein the cooperating instrumentalities defined by said lock actuator and said base comprises: a cooperating pair of camming surfaces defined by said base and said lock actuator, with said camming surfaces being configured to move into and out of engagement relative to each other depending upon the position of said lock actuator.

34. The door latching mechanism according to claim 28, wherein said handle includes a narrowed free-ended handle portion joined to a mounting portion which is pivotable about said first axis.

35. The door latching mechanism according to claim 34, wherein the cooperating instrumentalities defined by said lock actuator and said base comprises: a pair of upright spaced leg flanges on said base which are disposed to opposed sides of the mounting portion of said handle, and depending spaced flanges on said lock actuator which are disposed to opposed sides of the mounting portion of said handle, and with confronting surfaces on the upright spaced leg flanges on said base and the depending spaced flanges on said lock actuator each include camming surfaces configured to act in concert with each other to releasably secure said handle in the first position while allowing said handle to manually rotate so as to move said lock toward an unlocked condition upon manual rotation of said lock actuator.

36. The door latching mechanism according to claim 28, wherein said base includes an upstanding leg which, after said base is mounted within the recess defined by the door, extends away from the exterior surface of said door.

37. The door latching mechanism according to claim 36, wherein said lock actuator is spring biased and includes a pair of depending flanges disposed to opposed sides of a mounting portion of said handle and which are connected to each other by a bight portion which extends over the mounting portion of said handle, and wherein said lock actuator is pivotally carried by said handle for manual rotation about said second axis extending generally parallel to said first axis, and with the bight portion of said handle acting as a stop for limiting pivotal movement of said lock actuator in a first pivotal direction about said second axis.

38. The door latching mechanism according to claim 37, wherein the mounting portion of said handle and the bight portion of said lock actuator each define openings, with peripheral edges of said openings being sized relative to each other to allow the upstanding leg on said base to project therethrough when said handle is in said first position.

39. The door latching mechanism according to claim 38, wherein the cooperating instrumentalities defined by said lock actuator and said base comprises: a tab movable with the lock actuator for removably engaging an open-sided notch defined by the upstanding leg on said base to releasably retain the handle in said first position, and with the tab on said lock actuator being removable from said notch upon pivotal rotation of said lock actuator to a released position to disengage said cooperating instrumentalities and allow said handle to manually rotate said lock toward the unlocked condition whereby permitting said door to be positioned to permit access to the container interior.

40. The door latching mechanism according to claim 38, wherein the upstanding leg on said base has a camming surface for facilitating return said cooperating instrumentalities from the released position to a position wherein the cooperating instrumentalities secure said handle in a first position.

41. The door latching mechanism according to claim 38, wherein the upstanding leg on said base and the mounting portion on said handle are configured to accommodate an indicator capable of indicating whether the lock actuator has been rotated about the second axis to move said handle from the first position.

42. A method for conditioning lock assembly so as to releasably hold a cargo container door in a closed position relative to an opening in a side of the cargo container, and with said lock assembly having a movable lock member which operably interacts with a stationary lock member, said method comprising the steps of:
securing a door latching mechanism to an exterior side of said door, with said door latching mechanism including a base operably secured to the exterior side of said door,
mounting a manually operable handle to said base for movements about a first axis, with said handle being operably connected to and operates said lock assembly in response to pivotal movement of said handle about said first fixed axis;
providing a lock actuator on said handle for movement about a second axis and configured to facilitate one handled operation of said door latching mechanism, with said lock actuator and said base defining cooperating instrumentalities for either releasably securing said handle in a first position, wherein said cooperating instrumentalities engage to inhibit movement of said handle and thereby said lock assembly to an unlocked condition, and with said lock actuator being movable to disengage said cooperating instrumentalities and allow said handle to manually move said lock assembly toward the unlocked condition whereby permitting said door to be positioned to permit access to an interior of said container.

43. The method for conditioning lock assembly so as to releasably hold a cargo container door in a closed position relative to an opening in a side of the cargo container according to claim 42 including the further step of:
recessing the door latching mechanism from the exterior side of the door to inhibit inadvertent operation of the door latching mechanism.
